(19) United States
(12) Patent Application Publication
(10) Pub. No.: US 2018/0124901 A1
(43) Pub. Date: May 3, 2018

(54) SPEECH-ACTIVATED DIMMABLE LED

(71) Applicant: Sampath Sripathy, Philadelphia, PA (US)

(72) Inventor: Sampath Sripathy, Philadelphia, PA (US)

(21) Appl. No.: 15/782,824

(22) Filed: Oct. 12, 2017

Related U.S. Application Data
(60) Provisional application No. 62/407,430, filed on Oct. 12, 2016.

(51) Int. Cl. H05B 37/02; H05B 33/08; G10L 15/22

(52) U.S. Cl. CPC H05B 37/0236; G10L 15/22; H05B 33/0845

(57) ABSTRACT

An LED lighting system provides for the output light intensity of the LEDs in the LED lighting system to be adjusted. Electronic Circuits in the LED lighting system configure the lighting system to vary its light intensity based on information provided by Speech Commands.

### CROSS-REFERENCE TO RELATED APPLICATIONS

The present application claims the priority of U.S. Provisional Application for Patent Ser. No. 62/407,430, filed on Oct. 12, 2016, which is incorporated by reference herein in its entirety.

### BACKGROUND OF THE INVENTION

The lighting industry is going through a tremendous change in last few years, especially with LED Lighting capturing the market. With the banning of certain common Incandescent light lamps for the residential market by the U.S. Government, lighting manufacturers were forced to invent new technologies for the light bulb. The sales of incandescent bulbs are expected to plummet. The need persists in the art for a dimmable LED lighting system that allows for hands-free operation. The need also persists in the art for a dimmable LED lighting system that is “hack-proof,” that does not require modification of the existing building circuitry, and that does not require the repeated manipulation of a wall or on/off switch, which can lead to arcing and lead to other hazards.

### SUMMARY OF THE INVENTION

The present invention is directed to a speech-activated dimmable lighting system that allows an LED lamp or the like to be dimmed or brightened by voice command. The present invention allows the dimmable LED lamp to be installed in a standard on/off controlled light socket while allowing the energy savings and added functionality of a dimmable light to be realized without any modification to the electric circuit of the light socket being necessary.

Accordingly, it is an aspect of the present invention to provide a speech-activated lighting system comprising:

a light source for emitting light;

a speech converting block for converting a spoken command phrase to a command signal;

a microcontroller generating a control signal corresponding to the command signal outputted by the speech converting block; and

a driver allowing the supply of power to the light source at a level responsive to the control signal outputted by the microcontroller to thereby provide light of variable intensity from the light source responsive to the spoken command phrase.

It is another aspect of the present invention to provide a speech-activated lighting system incorporating any of the above-described aspects of the present invention, wherein the light source is selected from the group consisting of one or more LEDs, one or more OLEDs, a LED array, an OLED array, tube lights, down lights, and combinations thereof.

It is still another aspect of the present invention to provide a speech-activated lighting system incorporating any of the above-described aspects of the present invention, wherein the speech converting block comprises a microphone and a low-pass filter.

It is yet another aspect of the present invention to provide a speech activated lighting system incorporating any of the above-described aspects of the present invention, wherein the speech converting block further comprises a CODEC that outputs the command signal corresponding to the spoken command phrase.

It is yet another aspect of the present invention to provide a speech activated lighting system incorporating any of the above-described aspects of the present invention, wherein the speech converting block further comprises a pre-amplifier with automatic gain control (AGC) that receives an electrical microphone signal from the microphone and outputs a conditioned microphone signal to the low-pass filter.

It is yet another aspect of the present invention to provide a speech activated lighting system incorporating any of the above-described aspects of the present invention, wherein the speech converting block further comprises a pre-amplifier with automatic gain control (AGC) that receives an electrical microphone signal from the microphone and outputs a conditioned microphone signal before the conditioned microphone signal reaches the CODEC.

It is yet another aspect of the present invention to provide a speech activated lighting system incorporating any of the above-described aspects of the present invention, wherein the speech converting block further comprises an analog-to-digital (A/D) converter that outputs the command signal corresponding to the spoken command phrase.

It is yet another aspect of the present invention to provide a speech activated lighting system incorporating any of the above-described aspects of the present invention, wherein the microcontroller comprises a microprocessor, memory, and input/output circuitry.

It is yet another aspect of the present invention to provide a speech activated lighting system incorporating any of the above-described aspects of the present invention, wherein the input/output circuitry includes at least one of a network interface and a cellular interface.

It is yet another aspect of the present invention to provide a speech activated lighting system incorporating any of the above-described aspects of the present invention, wherein the memory includes at least one of RAM memory and flash memory.

It is yet another aspect of the present invention to provide a speech activated lighting system incorporating any of the above-described aspects of the present invention, wherein the speech-activated lighting system further comprises an input filter and a bridge rectifier for supplying direct current to at least the microcontroller from an alternating current supply of power.

It is yet another aspect of the present invention to provide a speech activated lighting system incorporating any of the above-described aspects of the present invention, wherein the driver is a MOSFET transistor.

It is yet another aspect of the present invention to provide a speech activated lighting system incorporating any of the above-described aspects of the present invention, wherein the speech converting block is further adapted for converting a spoken trigger phrase to a trigger signal, and wherein the microcontroller enters a set-up/configuration mode in response to the trigger signal outputted by the speech converting block.

It is yet another aspect of the present invention to provide a speech activated lighting system incorporating any of the above-described aspects of the present invention, wherein the microcontroller is responsive to the spoken command phrase when the microcontroller is in the set-up/configuration mode.

It is yet another aspect of the present invention to provide a speech activated lighting system incorporating any of the above-described aspects of the present invention, wherein the light source has a maximum light intensity, wherein the intensity of the light emitted by the light source can assume any one of a plurality of different intensity levels up to and including the maximum light intensity responsive to the power allowed to the light source by the driver, and wherein the microcontroller is programmed to supply power to the light source at a user selected one of the plurality of different intensity levels responsive to the command phrase.

It is yet another aspect of the present invention to provide a speech activated lighting system incorporating any of the above-described aspects of the present invention, wherein the command phrase is one of a plurality of command phrases, and a different one of the plurality of command phrases uniquely identifies each of the plurality of different intensity levels.

It is yet another aspect of the present invention to provide a speech activated lighting system incorporating any of the above-described aspects of the present invention, wherein the command phrase is one of a plurality of command phrases, wherein one or more of the plurality of command phrases is used for selecting the intensity level of the light source, and wherein the plurality of command phrases includes one or more command phrases corresponding to functions, other than selecting the intensity level of the light source, involved in programming, setting up, or configuring the speech-activated lighting system in addition to the command phrases used for selecting the intensity level of the light source.

It is yet another aspect of the present invention to provide a speech activated lighting system incorporating any of the above-described aspects of the present invention, wherein the command signal outputted by the speech converting block is communicated to the microcontroller wirelessly.

It is yet another aspect of the present invention to provide a speech activated lighting system incorporating any of the above-described aspects of the present invention, wherein the command signal outputted by the speech converting block is communicated to the microcontroller via a telecommunication, computer, or cellular network.

It is yet another aspect of the present invention to provide a speech activated lighting system incorporating any of the above-described aspects of the present invention, wherein the speech converting block is formed by a mobile device executing an application program specifically designed to allow the mobile device to perform the functions of the speech converting block.

It is yet another aspect of the present invention to provide a speech activated lighting system incorporating any of the above-described aspects of the present invention, wherein the speech converting block converts the microphone signal to a digital signal comprising a coded string of text characters representing the text of one or both of the spoken trigger phrase and the spoken command phrase.

These and other aspects and advantages of the present invention will be further elucidated by the following Detailed Description, drawing figures, and Claims.

### BRIEF DESCRIPTION OF THE DRAWING FIGURES

FIG. 1 shows a typical existing wiring in a residential environment of a Dimmable LED Lamp connected to commercial existing phase-cut Dimmer in the residence to achieve the desired Light intensity of the LED Lamp.

FIG. 2 shows a typical existing wiring in a residential environment of a Regular LED Lamp connected to existing ON/OFF switch in the residence.

FIG. 3 shows an embodiment of the speech-activated dimmable lighting system according to the present invention.

FIG. 4 shows a second embodiment of the speech-activated dimmable lighting system according to the present invention.

Reference numerals identifying various parts of the present invention are used consistently throughout the appended drawings.

### DETAILED DESCRIPTION

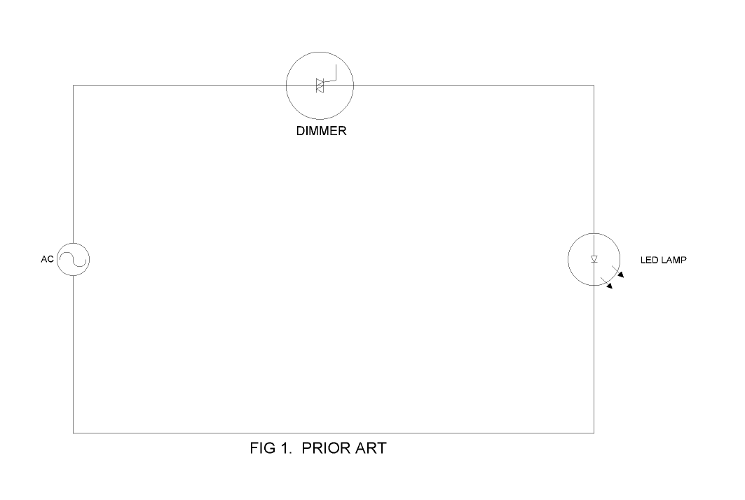

FIG. 1 shows a typical existing wiring in a residential environment of a Dimmable LED Lamp connected to commercial existing phase-cut Dimmer in the residence to achieve the desired Light intensity of the LED Lamp.

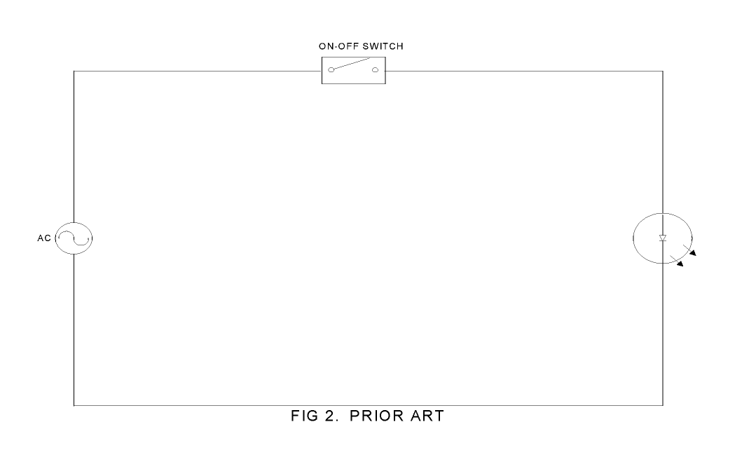

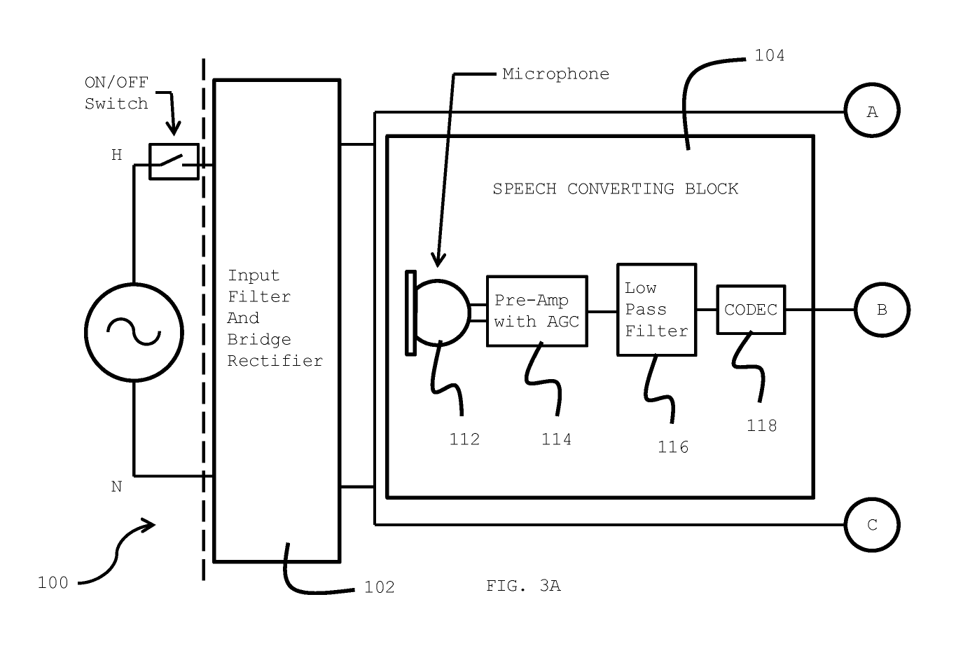

FIG. 2 shows a typical existing wiring in a residential environment of a Regular LED Lamp connected to existing ON/OFF switch in the residence. This does not provide any dimming capability with prior art lamps.

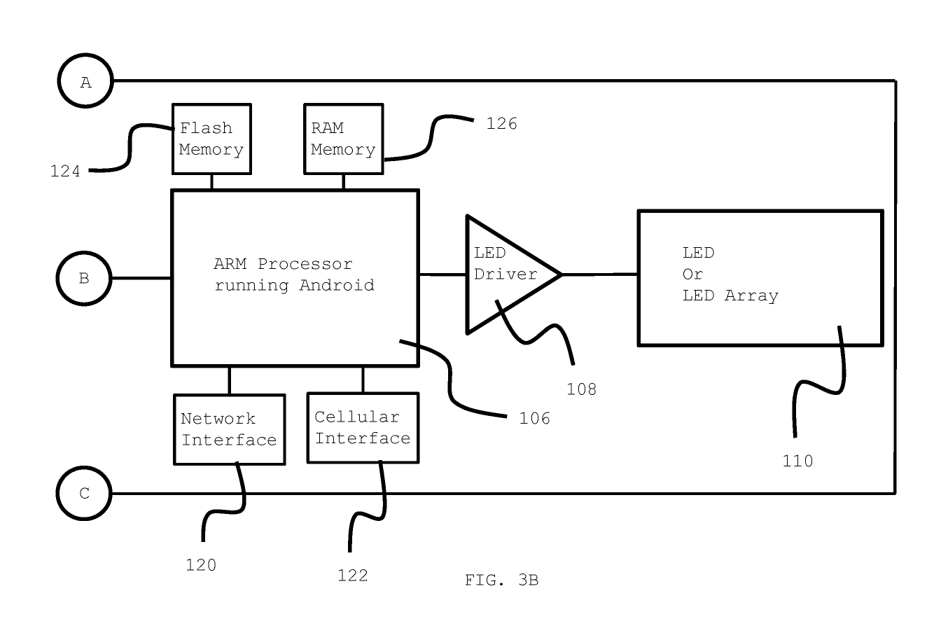

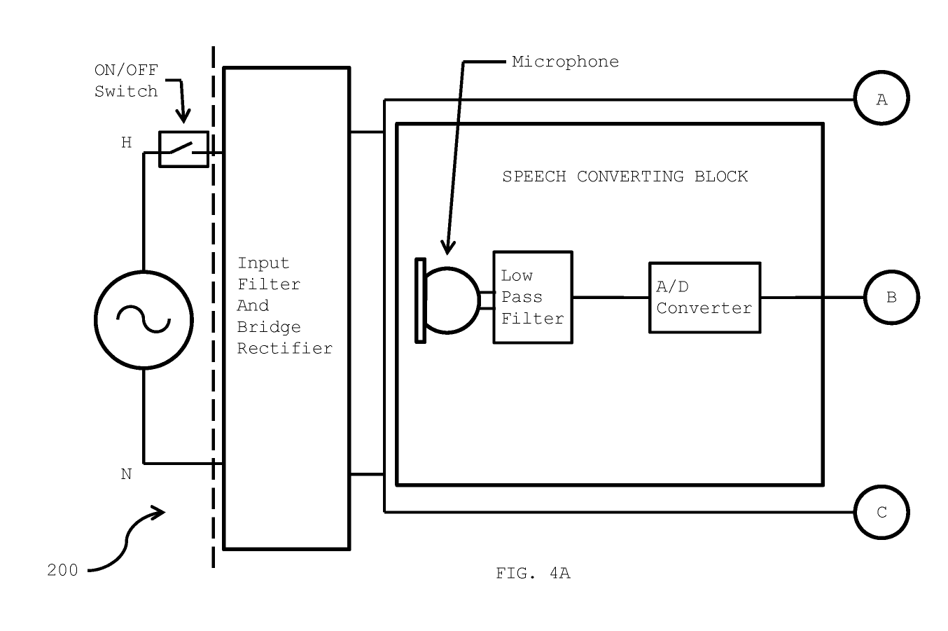

Referring to FIG. 3, an embodiment 100 of the present invention can be seen. An LED lamp is provided in which the output light intensity of the LEDs in the LED lamp is adjustable. Electronic Circuits in the LED Lamp configure the lamp to vary its light intensity based on information provided by Speech Commands. The terms “lamp” and “lighting system” are used interchangeably herein to refer to a lighting system that includes the light source and its associated control circuitry, except when it is apparent from the context that “lamp” is referring to the light source apart from some or all its associated circuitry.

Using the detected Speech Command or the Trigger Phrase the electronic circuits and the Software in the generates control signals appropriate for the detected Speech Command and provides light intensity control of the LED lamp to achieve the desired intensity of the LED Lamp OR detects a Trigger Phrase and goes into the Set-up Mode. These commands can be actual Speech Commands or optionally, signals sent via a wired or wireless interface or a Cellular phone or Digital tablet.

The LED lamp can be a direct replacement of conventional incandescent lamps in typical wiring configurations found in residential and commercial building lighting applications that use conventional ordinary ON/OFF switches, though an ON-OFF switch is optional for the speech-activated dimmable lighting system 100.

FIG. 3 the speech-activated dimmable lighting system of the present invention, which is a Speech Activated Dimmable LED Lamp containing electronic circuits to sense Speech Commands and to provide control in the configuration of the Lighting System 100 and the proper intensity control of the LED lamp based on information provided by the Speech Command. The Lighting System 100 is a circuit that can detect a Speech Command, which can be a Trigger Phrase followed by a Speech Command Phrase. These Trigger Phrases and the Command Phrases can be actual Human Speech Commands, or optionally, Command and Trigger Phrases sent over a wired or wireless network, including from a Cellular Phone or a Digital Tablet. Depending on the Command Phrase OR the Trigger Phrase, circuits within the LED Lamp will perform one of following operations:

1. Go to Set-up/configuration Mode

2. Turn the LED OFF

3. Turn the LED ON Fully

4. Go to Dimming Level ONE (75%)

5. Go to Dimming Level TWO (50%)

6. Go to Dimming Level THREE (25%)

7. Go to Dimming Level FOUR (10%)

8. Go on continuous Dimming, up or down, until a STOP command is issued.

Other Dimming Levels are possible. During the Set-up Mode the Lighting System 100 will be at 10% of full brightness and will be flashing ON and OFF every 2 seconds. In a residential application, Set-up/configuration mode is used to locate the Lighting System 100 in different areas of a typical residence, such as family room, living room etc. This eliminates interference among lighting systems 100 located in close proximity in different rooms. Once the Set-up Mode is completed the lighting system 100 will stop flashing, indicating the Set-up is complete and the Lighting system 100 is ready to accept Speech Commands. The Speech Activated Dimmable LED is software driven and the software is embedded in the microcontroller or resides in Flash Memory 124. The Lighting system 100 can be grouped when multiple LED lights are used, for example in a large living room. In a commercial environment different groups can be used to render different dimming levels to enhance the lighting effects.

FIG. 3 shows an ordinary ON/OFF switch connected to the Speech Activated Dimmable LED lamp 100. The ON-OFF switch is optional, shown for safety purposes. The complete electronic circuit, for sensing the type of Speech Command Phrase and the Speech Trigger Phrase, for providing appropriate control of the output intensity of the LED Lamp, is contained within the integrated LED Lamp or in a separate module driving LED Tube lights, Down Lights, or OLEDs.

The purpose of this invention is to design and provide a dimmable LED Lamp that can be used with a “Hands-Free” approach. Our invention does NOT need an Internet Connection. Nor does it need a Router in the residence. It is “HACK PROOF”

In a commercial/industrial environment this design could be applied to LED tube lights, LED lighting fixtures, either integrated within the LED lamp or as an external driver.

The Speech Activated Dimmable LED lighting system works with or without a standard ON/OFF switch and provides MULTIPLE DISCRETE brightness levels, 100% down to 25%, by Speech Commands, in steps of 25%. It is possible to have more discrete dimming levels that are smaller step size, depending on market demand and acceptance. It is also possible to have continuous up/down dimming commanded by speech input.

The complete circuitry for the Speech Activated Dimmable LED is contained in one or more Integrated Circuits, including Microprocessors and Microcontrollers, within the LED Lamp or in a separate enclosure. The block diagram of FIG. 3 details the functions of the various circuit blocks.

The block diagram in FIG. 3 shows a typical application of the lighting system of the present invention. The lighting system 100 includes a number of components or functional blocks. These include the Input Filter and Bridge Rectifier 102, the Speech Converting Block 104, The Microcontroller/Microprocessor 106 and the FINAL DRIVER 108 for the LED/LEDs 110. The final driver is referred to simply as the driver in the appended claims, it being understood that other elements may be inserted intermediate the driver and the LED, for example, fuses or other safety devices.

The Input Filter and Bridge rectifier 102 provides a DC Voltage to the lighting system 100. The Speech Converting Block 104 consists of a Microphone 112, a Microphone pre-amplifier with automatic gain control (AGC) 114, optional Low Pass Filter 116 and a Speech Codec 118. The function of the Speech Converting Block 104 is to convert Analog Speech (Speech) Input to Digital Signals. Software residing in the Microcontroller/Microprocessor memory is used to interpret these Digital Signals. These Speech Commands that are converted to Digital Signals are compared with a known set of Trigger and Command Phrases stored in a non-volatile manner in Flash memory 124. Only if a match occurs, depending on the Command or trigger Phrase, the Microcontroller/Microprocessor takes further action. Optionally Commands or Trigger phrases sent over the Network interface 120 or Cellular interface 122 could be used as Command or Trigger phrases. Optionally, the digital signals may be the representation of the text of the Speech Commands uttered by the user.

The Microcontroller/Microprocessor is an important component in the lighting system of the present invention. The memory, namely Flash 124 and RAM 126 can be separate or part of the Microcontroller. The Final Driver is typically a MOSFET transistor.

As an alternative, it is possible to program the microcontroller so that the same command phrase is used to sequentially navigate through the various lighting levels. As an example, the command phrases “up” or “down” may be repetitively used to reach the desired lighting level.

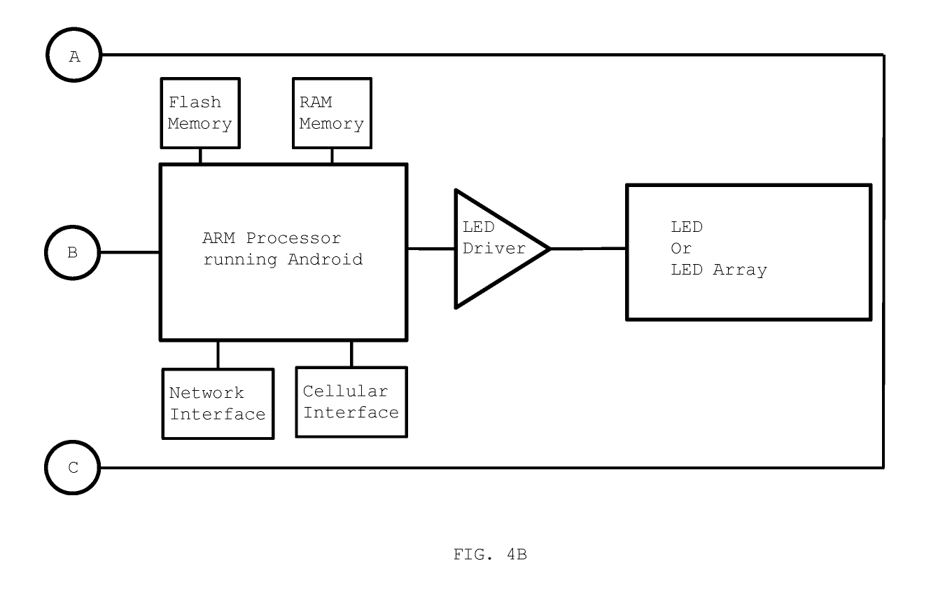

Referring to FIG. 4, a second embodiment 200 of the present invention can be seen. This embodiment is identical to the embodiment 100 except that the codec is replaced by an A/D converter. Although the pre-amplifier is not explicitly shown in embodiment 200, those of ordinary skill in the art would understand that the pre-amplifier is impliedly present as microphones typically incorporate pre-amplifiers. CODECs also include an A/D converter.

As used herein, “phrase” means one or more words, which may be contrived or made-up words.

It should be understood that the present invention is not limited to the specific embodiments described above, but includes any and all variations or modifications within the spirit and scope of the present invention as defined in the appended claims.

1. A speech-activated lighting system comprising:
a light source for emitting light;
a speech converting block for converting a spoken command phrase to a command signal;
a microcontroller generating a control signal corresponding to the command signal outputted by said speech converting block; and
a driver allowing the supply of power to said light source at a level responsive to the control signal outputted by said microcontroller to thereby provide light of variable intensity from said light source responsive to the spoken command phrase.

2. The speech-activated lighting system of claim 1, wherein said light source is selected from the group consisting of one or more LEDs, one or more OLEDs, a LED array, an OLED array, tube lights, down lights, and combinations thereof.

3. The speech-activated lighting system of claim 1, wherein said speech converting block comprises a microphone.

4. The speech-activated lighting system of claim 3, wherein said speech converting block further comprises a CODEC that outputs the command signal corresponding to the spoken command phrase.

5. The speech-activated lighting system of claim 4, wherein said speech converting block further comprises a pre-amplifier with automatic gain control (AGC) that receives an electrical microphone signal from said microphone and outputs a conditioned microphone signal before the conditioned microphone signal reaches the CODEC.

6. The speech-activated lighting system of claim 3, wherein said speech converting block further comprises an analog-to-digital (A/D) converter that outputs the command signal corresponding to the spoken command phrase.

7. The speech-activated lighting system of claim 1, wherein said microcontroller comprises a microprocessor, memory, and input/output circuitry.

8. The speech-activated lighting system of claim 7, wherein said input/output circuitry includes at least one of a network interface and a cellular interface.

9. The speech-activated lighting system of claim 7, wherein said memory includes at least one of RAM memory and flash memory.

10. The speech-activated lighting system of claim 1, wherein the speech-activated lighting system further comprises an input filter and a bridge rectifier for supplying direct current to at least said microcontroller from an alternating current supply of power.

11. The speech-activated lighting system of claim 1, wherein said driver is a MOSFET transistor.

12. The speech-activated lighting system of claim 1, wherein said speech converting block is further adapted for converting a spoken trigger phrase to a trigger signal, and wherein said microcontroller enters a set-up/configuration mode in response to the trigger signal outputted by said speech converting block.

13. The speech-activated lighting system of claim 12, wherein said microcontroller is responsive to the spoken command phrase when said microcontroller is in the set-up/configuration mode.

14. The speech-activated lighting system of claim 1, wherein the light source has a maximum light intensity, wherein the intensity of the light emitted by said light source can assume any one of a plurality of different intensity levels up to and including the maximum light intensity responsive to the power allowed to said light source by said driver, and wherein said microcontroller is programmed to supply power to said light source at a user selected one of the plurality of different intensity levels responsive to the command phrase.

15. The speech-activated lighting system of claim 14, wherein the command phrase is one of a plurality of command phrases, and a different one of the plurality of command phrases uniquely identifies each of the plurality of different intensity levels.

16. The speech-activated lighting system of claim 14, wherein the command phrase is one of a plurality of command phrases, wherein one or more of the plurality of command phrases is used for selecting the intensity level of said light source, and wherein the plurality of command phrases includes one or more command phrases corresponding to functions, other than selecting the intensity level of said light source, involved in programming, setting up, or configuring the speech-activated lighting system in addition to the command phrases used for selecting the intensity level of said light source.

17. The speech-activated lighting system of claim 1, wherein the command signal outputted by said speech converting block is communicated to said microcontroller wirelessly.

18. The speech-activated lighting system of claim 1, wherein the command signal outputted by said speech converting block is communicated to said microcontroller via a telecommunication, computer, or cellular network.

19. The speech-activated lighting system of claim 14, wherein said speech converting block is formed by a mobile device executing an application program specifically designed to allow the mobile device to perform the functions of said speech converting block.

20. The speech-activated lighting system of claim 12, wherein the trigger signal and the command signal are digital signals comprising a coded string of text characters representing the text of the spoken trigger phrase and the spoken command phrase, respectively.
